(19) United States
(12) Patent Application Publication
(10) Pub. No.: US 2026/0158469 A1
(43) Pub. Date: Jun. 11, 2026

(54) PROCESS FOR PRODUCING A PLATE-SHAPED BUILDING MATERIAL WITH MOISTURE-ABSORBING PROPERTIES

(71) Applicant: MAGU Swiss AG, Schaffhausen (DE)

(72) Inventor: Stefan Günthner, Schaffhausen (CH)

(21) Appl. No.: 19/378,490

(22) Filed: Nov. 4, 2025

(30) Foreign Application Priority Data
Nov. 7, 2024 (EP) 24211553.3

(51) Int. Cl. B01J 20/32; B01J 20/02; B01J 20/28

(52) U.S. Cl. CPC B01J 20/3223; B01J 20/02; B01J 20/28016; B01J 20/3202; B01J 20/3234; B01J 2220/42

(57) ABSTRACT

The present disclosure pertains to a method for coating nub structures and nub panels, in particular thermal insulation panels, which are used in the construction industry. The method provides for the components of the coating to be applied in separate steps and in a production line, enabling uniform coating of all surfaces.

### BACKGROUND OF THE INVENTION

### 1) Field of the Invention

The invention relates to a method for producing a plate-shaped building material with moisture-absorbing properties, which can be used, for example, for renovating or drying flat roofs or other building elements.

### 2) Description of Related Art

In the field of construction, it is known to use nub panels coated with a moisture-absorbing material for drying and insulating flat roofs.

European patent application EP 1223261 describes how coated nub panels are used to renovate damp flat roofs. The hydrophilic, usually cementitious coating of the nub panel ensures that the underlying layers dry out quickly and allows the old roof structure to be preserved. Applications similar in terms of building physics, such as the drying of horizontal surfaces such as damp screeds, concrete components, or ceilings and/or vertical components such as walls, can be carried out accordingly.

In the state of the art, the hydrophilic coating is usually sprayed onto the nub panels, or the nub panels are immersed in a coating bath. However, the coating methods mentioned have various disadvantages. On the one hand, large quantities of the coating material must be premixed and kept in stock, which results in deposits. Furthermore, the curing of the mixed coating material causes problems and makes it difficult to handle and clean the equipment. In addition, the amount of material required is increased. Furthermore, due to the usually high viscosity of the mixed coating compound, it is usually not possible to homogeneously coat all necessary vertical and/or horizontal surfaces, and in particular the edges of the nub panel. This results in varying and often excessive application thicknesses.

### BRIEF SUMMARY OF THE INVENTION

The object of the present invention is therefore to provide an improved method for coating nub panels, by means of which the moisture-absorbing coating is applied evenly to all surfaces, including the vertical or possibly also conical flanks of the nubs, and the disadvantages of mixing the coating material with the undesirable effects of deposition, increased cleaning and maintenance costs, higher material requirements of the coating material.

This task is solved according to the invention by the features specified in independent patent claims. Further embodiments of the invention are set out in the dependent claims.

### Solution to the Problem

The invention provides a method in which the moisture-absorbing layer is applied to a nub structure in a preferably multi-stage process. The various components, such as adhesive and coating material, can be applied spatially in one place or in successive steps at different locations—comparable to a production line. This enables flexible and efficient handling of the coating process.

According to the invention, a first method for producing a plate-shaped building material with moisture-absorbing properties is proposed, which comprises at least the following steps:
providing a plate-shaped nub structure;
applying an adhesive to the nub structure; and
applying a moisture-absorbing coating material in powder form.

The application of adhesive and coating material can be carried out in successive process steps. In the alternative, both materials can also be applied simultaneously, for example by conveying a powdered coating material onto the nub structure, whereby it is mixed with an adhesive while still in the air (before it reaches the surface of the nub structure). The powdered coating material can, for example, trickle down onto the nub structure under the influence of gravity and be sprayed with an adhesive while it is still in the air. The moistened coating material then falls onto the nub structure and adheres there. The coating process can take place in a vortex chamber, for example.

According to the invention, the powdered coating material can be dry or slightly moistened.

In addition, an alternative second method for producing a plate-shaped building material with moisture-absorbing properties is proposed, which comprises at least the following steps: providing a plate-shaped nub structure; applying a moisture-absorbing coating material in powder form to the nub structure without first applying an adhesive to it; and applying a binding agent to the nub structure to bind the previously applied coating material.

According to a specific embodiment of the invention, the nub structure is provided with an adhesive before the moisture-absorbing coating material is applied and with a binding agent after the coating material has been applied. Such a method then comprises at least the following steps: providing a plate-shaped nub structure; Applying an adhesive to the nub structure; applying a moisture-absorbing coating material in powder form to the nub structure; and applying a binding agent to the nub structure to bind the coating material.

The aforementioned steps 2 (application of adhesive) and 3 (application of coating material) and/or steps 3 (application of coating material) and 4 (application of binding agent) can be carried out either in successive steps or simultaneously.

The adhesive mentioned is, in particular, an adhesive substance that ensures the adhesion and bonding of the coating material to the mostly hydrophobic surface of the nub structure. The adhesive substance can be, for example, water or an aqueous solution or a polymer-modified emulsion.

The adhesive can be sprayed onto the nub structure using nozzles, for example. However, the nub structure can also be dipped into an adhesive bath to evenly wet all vertical and horizontal surfaces of the nub plate. This ensures that all relevant surfaces are wet or coated with emulsion and are suitably prepared for the subsequent coating.

The nub structure can consist, for example, of foam, in particular polystyrene, or be a separating layer.

According to the invention, the term “plate-shaped nub structure” refers to any plate-shaped or layer-like material that has outwardly protruding areas—the “nubs”—which give the structure an enlarged surface area. Nubs can have the form of studs or ribs, for example.

According to a specific embodiment of the invention, the nub structure is a nub plate or a plate-shaped grid structure with nubs or a nub web, which can be wound into a roll, for example. In the case of a grid structure, this can be coated first, for example, and then attached to a plate in a subsequent step. The use of a nub grid has the advantage that the coating can be applied without obstruction by additional components, resulting in an even and efficient application of the coating material.

In a first embodiment of the invention, the coating material comprises cement and sand. In a second embodiment of the invention, the coating material is cement-free and may comprise, for example, gypsum.

The coating material is preferably applied to the nub structure in a closed chamber in order to create a controlled environment and prevent contamination. The material, which is preferably provided in powder form, can be evenly scattered into the closed chamber via a close-meshed net or a slotted plate by means of a mechanical slide device. The arrangement and size of the meshes or slots are selected so that the coating material trickles evenly and uniformly into the chamber below due to the movement of the slider, but remains on the screen, mesh, or plate without the slider moving. Air nozzles can be used to swirl the material so that it settles evenly on all areas of the nub structure, including the hard-to-reach dimple flanks. The air nozzles, which cause sufficient turbulence in the material, can be activated alternately from different sides. The distance between the atomization device and the nub plate—i.e., the height of the turbulence chamber is selected so that the powdered material is atomized evenly.

According to the invention, the coating material can therefore be applied to the nub structure, for example, in a vortex chamber and/or by means of air nozzles.

The binding agent mentioned before can be, for example, water, an emulsion, or a polymer-modified binding dispersion. The binding agent is preferably applied to the partially dry powder surface by means of nozzles. The sprayed film serves to bind the dry or wet-applied coating material. This process step can be repeated several times if necessary to ensure an even layer with the required thickness and absorbency.

According to the invention, the nub structure can also be arranged with the nubs facing downwards and coated from below. For example, an adhesive can first be sprayed onto the underside and then a powdered coating material can be applied using nozzles. According to one embodiment of the invention, both sides of the nub structure can also be coated. The nub structure can also have nubs on both sides.

This innovative method of applying the moisture-absorbing coating allows the coating process to be flexibly adapted to different conditions and ensures that the coating material is applied homogeneously and evenly. The method according to the invention also has the advantage that only as much water is used as the coating material, which is usually cement-based, requires for setting. Thus, this type of coating also significantly minimizes the subsequent drying of the coating.

### Advantages of the Invention

There is no need to premix cement-bound coating compounds, which optimizes material consumption and facilitates cleaning.

The water-absorbing layer is applied evenly to all surfaces of the nub plate, including the hard-to-reach vertical and conical flanks.

The process offers flexibility in the sequence and location of the coating processes, enabling efficient manufacturing in a production line.

The setting time of the applied coating material is significantly reduced through the economical use of water and/or an adhesive emulsion.

### BRIEF DESCRIPTION OF THE DRAWINGS

The invention is explained in more detail below with reference to the accompanying drawings. They show:

FIG. 1 shows a view of a first process step in which a nub structure is sprayed with an adhesive;

FIG. 2 show a perspective view of a vortex chamber for applying a powdered coating material to a nub structure; and

FIG. 3 shows a view of a third process step in which a binding agent is sprayed onto a nub structure.

### DETAILED DESCRIPTION

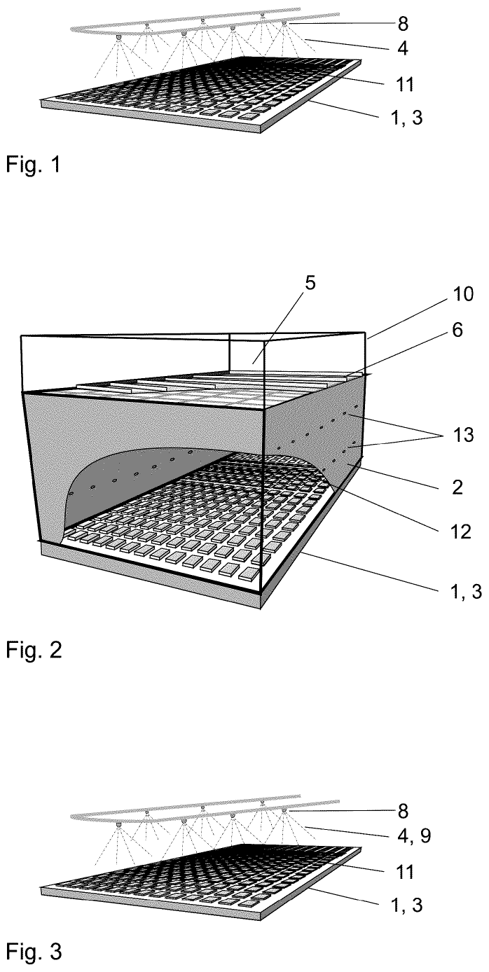

FIG. 1 shows a first process step of a method for producing a plate-shaped nub structure 1 with moisture-absorbing properties. In this process, a nub structure 1 is sprayed with an adhesive 4, such as water or an aqueous solution, by means of nozzles 8. The adhesive agent 4 serves to ensure the adhesion of a coating material 5 applied later to the mostly hydrophobic surface of the nub structure 1. The coating material 5 gives the nub structure 1 its moisture-absorbing property. It can be, for example, a powdery mixture of cement and sand, but can also be cement-free.

In this embodiment, the nub structure 1 is a nub plate 3 made of EPS, which has a plurality of dimples 11 on its surface. The dimples 11 point upwards and the nozzles 8 are located above the nub plate 3.

FIG. 2 shows a perspective view of a vortex chamber 2 for applying a powdered coating material 5 to the previously moistened nub plate 3. The vortex chamber 2 comprises a feed container 10 located at the top, which is filled with the powdered coating material 5. The powdered coating material 5 is evenly scattered into a closed chamber 12 by means of a mechanical slide device 6 via a close-meshed net or a slotted plate. The arrangement and size of the meshes or slots are selected so that the coating material 5 trickles evenly into the chamber 12 below due to the movement of the slide device 6, but remains on the screen, mesh, or plate when the device is not moving. The nub plate 3 lies on the floor of the vortex chamber 2. The vortex chamber 2 also comprises air nozzles 13, which are used to swirl the coating material 5 so that it settles evenly on all areas of the nub plate 3, including the hard-to-reach nub flanks. The air nozzles 13 can be activated alternately from different sides. The distance between the slide device 6 and the nub plate 3, i.e., the height of the vortex chamber 2, is selected so that the powdered material 5 is atomized evenly.

After the coating material 5 has been applied to the nub plate 3, the coating material 5 is sprayed with a binding agent 9, which serves to bind the dry or wet-applied coating material 5. FIG. 3 shows the spraying of the nub plate 3 by means of nozzles 8. This process step can be repeated several times if necessary to ensure an even layer of coating material 5 with the required thickness and absorbency. The binding agent 9 can be water, an aqueous solution, or a dispersion.

1. A method for producing a plate-shaped building material with moisture-absorbing properties, comprising at least the following steps:
applying an adhesive to a nub structure and
applying a moisture-absorbing coating material in powder form to the nub structure provided with the adhesive.

2. The method for producing a plate-shaped building material with moisture-absorbing properties according to claim 1, comprising at least the following steps:
applying an adhesive to a nub structure;
applying a moisture-absorbing coating material in powder form to the nub structure; and
applying a binding agent to the nub structure to bind the previously applied coating material.

3. The method according to claim 1, wherein the nub structure is a nub plate or a grid structure with nubs.

4. The method according to claim 1, wherein the adhesive is an emulsion, a dispersion, or water.

5. A method for producing a plate-shaped building material with moisture-absorbing properties, comprising at least the following steps:
applying a moisture-absorbing coating material in powder form to a nub structure without first providing it with an adhesive, and
applying a binding agent to the nub structure to bind the previously applied coating material.

6. The method according to claim 5, wherein the coating material comprises cement and sand.

7. The method according to claim 5, wherein the coating material is cement-free.

8. The method according to claim 5, wherein the coating material is applied to the nub structure in a vortex chamber and/or by means of air nozzles.

9. The method according to claim 8, wherein the grid-like nub structure is subsequently attached to a supporting structure, for example a plate, by gluing or mechanical fastening.

10. The method according to claim 5, wherein the coating material is applied to the nub structure from below.

11. The method according to claim 5, wherein the binding agent is an emulsion, a dispersion, or water.
